(19) United States
(12) Patent Application Publication
(10) Pub. No.: US 2025/0016011 A1
(43) Pub. Date: Jan. 9, 2025

(54) SYSTEMS AND TECHNIQUES FOR PROCESSING NON-FUNGIBLE TOKENS

(71) Applicant: NAGRAVISION SARL, CHESEAUX-SUR-LAUSANNE (CH)

(72) Inventors: Nathan Hamiel, Atlanta, GA (US); Vishruta Gowda Rudresh, Atlanta, GA (US); Ryan Spanier, Atlanta, GA (US)

(73) Assignee: NAGRAVISION SARL, CHESEAUX-SUR-LAUSANNE (CH)

(21) Appl. No.: 18/712,631

(22) PCT Filed: Nov. 29, 2022
(86) PCT No.: PCT/US2022/051168

§ 371 Date: May 22, 2024

Related U.S. Application Data
(60) Provisional application No. 63/284,536, filed on Nov. 30, 2021.
(60) Provisional application No. 63/284,538, filed on Nov. 30, 2021.
(60) Provisional application No. 63/284,540, filed on Nov. 30, 2021.
(60) Provisional application No. 63/284,542, filed on Nov. 30, 2021.
(60) Provisional application No. 63/284,546, filed on Nov. 30, 2021.

(51) Int. Cl. H04L 9/00; H04L 9/08; H04L 9/32

(52) U.S. Cl. CPC H04L 9/50; H04L 9/0825; H04L 9/3236; H04L 2209/608

(57) ABSTRACT

Aspects of the present disclosure include systems and techniques for processing non-fungible tokens. In some aspects, the techniques described herein relate to a method for non-fungible token (NFT) processing, including: encrypting information associated with an NFT using a first key of a key pair to yield encrypted NFT information; retrieving, from at least two entities, at least two key sections associated with a second key of the key pair: decrypting the encrypted NFT information associated with the NFT via the at least two key sections to yield decrypted NFT information; and outputting the decrypted NFT information.

### CROSS-REFERENCE TO RELATED APPLICATION

This application claims priority to provisional patent application U.S. Ser. No. 63/284,536 filed on Nov. 30, 2021, to provisional patent application U.S. Ser. No. 63/284,538 filed on Nov. 30, 2021, to provisional patent application U.S. Ser. No. 63/284,540 filed on Nov. 30, 2021, to provisional patent application U.S. Ser. No. 63/284,542 filed on Nov. 30, 2021, and to provisional patent application U.S. Ser. No. 63/284,546 filed on Nov. 30, 2021, the content of which are incorporated by reference herein in its entireties.

### FIELD

The present disclosure generally relates to non-fungible tokens. For example, aspects of the present disclosure include systems and techniques for processing non-fungible tokens.

### BACKGROUND

A non-fungible token (NFT) is a security including digital data that may be stored in a blockchain. For example, the blockchain may include a distributed ledger that may be used to record ownership of the NFT. The blockchain may be used to transfer ownership of the NFT so that the NFT may be traded. An NFT may include a reference (e.g., a link) to an object or file such as photos, videos, and audio. NFTs are non-fungible since they are uniquely identifiable.

### SUMMARY

In some aspects, the techniques described herein relate to a method for non-fungible token (NFT) processing, including: encrypting information associated with an NFT using a first key of a key pair to yield encrypted NFT information; retrieving, from at least two entities, at least two key sections associated with a second key of the key pair; decrypting the encrypted NFT information associated with the NFT via the at least two key sections to yield decrypted NFT information; and outputting the decrypted NFT information.

In some aspects, the techniques described herein relate to a method for NFT generation, including: receiving an object for generation of an NFT; processing the object to identify a characteristic of the object; identify one or more geographical regions where the NFT associated with the object can be sold based on the characteristic of the object; receiving a selection of at least one of the one or more geographical regions; and listing the NFT in the at least one of the one or more geographical regions in accordance with the selection.

In some aspects, the techniques described herein relate to a method for NFT processing, including: extracting information associated with an NFT in response to a request for an object corresponding to the NFT; retrieving the object corresponding to the NFT; encoding the information into the object to yield an encoded NFT object; and outputting the encoded NFT object.

### BRIEF DESCRIPTION OF THE DRAWINGS

Illustrative embodiments of the present application are described in detail below with reference to the following drawing figures:

FIG. 1 illustrates an example computing device, in accordance with certain aspects of the present inventive concept.

FIG. 2 is a diagram illustrating an illustrating example of a rights management system, in accordance with certain aspects of the present disclosure.

FIG. 3 is a diagram illustrating an example of a storage system for secure and high-fidelity storage of assets using multiparty computation (MPC), in accordance with certain aspects of the present disclosure.

FIG. 4 illustrates example operations for non-fungible token (NFT) processing, in accordance with certain aspects of the present disclosure.

FIG. 5 is a block diagram illustrating a credit creation system, in accordance with certain aspects of the present disclosure.

FIG. 6 illustrates example operations for NFT processing, in accordance with certain aspects of the present disclosure.

FIG. 7 is a block diagram illustrating an example content moderation system, in accordance with certain aspects of the present disclosure.

FIG. 8 illustrates example operations for NFT processing, in accordance with certain aspects of the present disclosure.

FIG. 9 is a block diagram illustrating an investment system, in accordance with certain aspects of the present disclosure.

FIG. 10 illustrates an architecture of a computing system.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

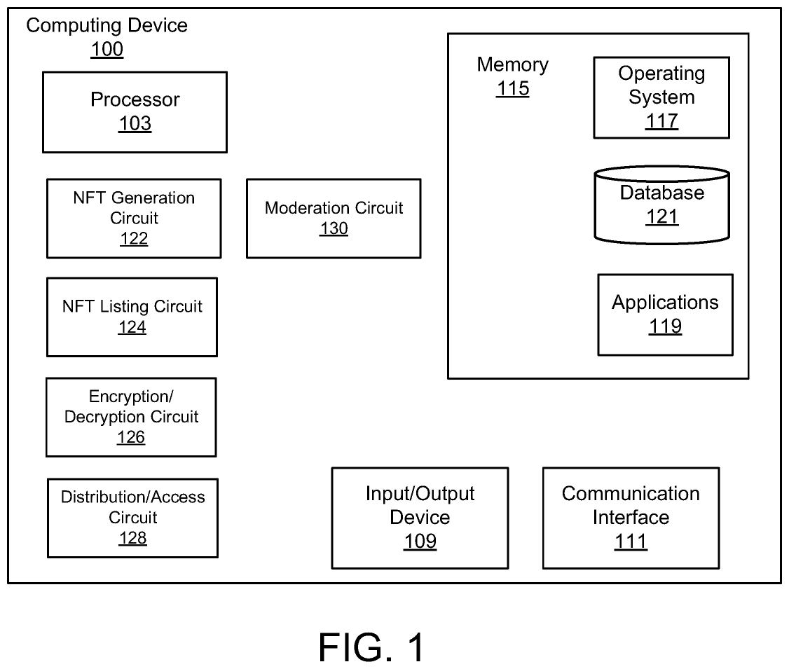

FIG. 1 illustrates an example computing device 100, in accordance with certain aspects of the present inventive concept. The computing device 100 can include a processor 103 for controlling overall operation of the computing device 100 and its associated components, including input/output device 109, communication interface 111, and/or memory 115. A data bus can interconnect processor(s) 103, memory 115, I/O device 109, and/or communication interface 111.

Input/output (I/O) device 109 can include a microphone, keypad, touch screen, and/or stylus through which a user of the computing device 100 can provide input and can also include one or more of a speaker for providing audio output and a video display device for providing textual, audiovisual, and/or graphical output. Software can be stored within memory 115 to provide instructions to processor 103 allowing computing device 100 to perform various actions. For example, memory 115 can store software used by the computing device 100, such as an operating system 117, application programs 119, and/or an associated internal database 121. The various hardware memory units in memory 115 can include volatile and nonvolatile, removable, and non-removable media implemented in any method or technology for storage of information such as computer-readable instructions, data structures, program modules or other data. Memory 115 can include one or more physical persistent memory devices and/or one or more non-persistent memory devices. Memory 115 can include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 103.

Communication interface 111 can include one or more transceivers, digital signal processors, and/or additional circuitry and software for communicating via any network, wired or wireless, using any protocol as described herein. Processor 103 can include a single central processing unit (CPU), which can be a single-core or multi-core processor (e.g., dual-core, quad-core, etc.), or can include multiple CPUs. Processor(s) 103 and associated components can allow the computing device 100 to execute a series of computer-readable instructions to perform some or all of the processes described herein. Although not shown in FIG. 1, various elements within memory 115 or other components in computing device 100, can include one or more caches, for example, CPU caches used by the processor 103, page caches used by the operating system 117, disk caches of a hard drive, and/or database caches used to cache content from database 121. For implementations including a CPU cache, the CPU cache can be used by one or more processors 103 to reduce memory latency and access time. A processor 103 can retrieve data from or write data to the CPU cache rather than reading/writing to memory 115, which can improve the speed of these operations. In some examples, a database cache can be created in which certain data from a database 121 is cached in a separate smaller database in a memory separate from the database, such as in RAM or on a separate computing device. For instance, in a multi-tiered application, a database cache on an application server can reduce data retrieval and data manipulation time by not needing to communicate over a network with a back-end database server. These types of caches and others can be included in various implementations and can provide potential advantages in certain implementations of software deployment systems, such as faster response times and less dependence on network conditions when transmitting and receiving data.

In certain aspects of the present disclosure, the computing device 100 may include a non-fungible token (NFT) generation circuit 122. The NFT generation circuit 122 may receive an object and generate an NFT for the object. The computing device 100 may also include an NFT listing circuit 124 that may be list an NFT on any suitable marketplace for sale. The computing device 100 may include an encryption/decryption circuit 126. Encryption/decryption circuit 126 may encrypt or decrypt an object (e.g., watermark or unwatermark an image) or metadata, as described herein. The computing device 100 may also include a distribution/access circuit 128, which may distribute assets or provide access to an asset based on one or more keys or shards, as described herein. In some aspects, the computing device 100 may also include a moderation circuit 130 that may moderate geographical areas where NFTs may be sold. In some aspects, NFT generation circuit 122, NFT listing circuit 124, encryption/decryption circuit 126, distribution/access circuit 128, and/or moderation circuit 130 may be implemented in software or hardware, or a combination of software and hardware. NFT generation circuit 122, NFT listing circuit 124, encryption/decryption circuit 126, distribution/access circuit 128, and/or moderation circuit 130 may be implemented as part of processor 103, in some aspects.

Some aspects of the present disclosure are directed toward using multiparty computation (MPC) for NFT rights management. In essence, NFTs are unique digital assets. The value of the NFT is determined by its scarcity, provenance, and utility. One characteristic that makes NFTs unique (apart from an identifier (ID) of the NFT) is the object they represent. The object can be any digital asset such as an image or video, sound, metaverse, or a digital representation of a physical asset, such as a painting or fashion apparel. However, digital assets lose their uniqueness the moment a copy of the asset is made. An NFT may lose its uniqueness property as the underlying digital asset loses its uniqueness. Because NFT objects (e.g., artwork) may be stored on centralized or decentralized databases and may be linked to an NFT, there is a possibility that the NFT object could be replaced by a copy of the NFT object, replaced by another digital file altogether, altered, deleted, moved and/or otherwise manipulated. There are also instances where an owner of an NFT may want to distribute copies of the NFT object, but would like to retain the uniqueness of the object they own, or the object creator may want to limit the owner of the NFT and the corresponding object from making copies and/or distributing the object without their consent.

In some cases, rules can be hard-coded into an NFT contract. For instance, the rules can define restrictions around the use of the NFT by the original NFT owner and any subsequent owners. However, these restrictions, as an extension, may be applicable only in essence to the objects the NFT represents. Systems and techniques are described herein that support the use of a cryptographically secure quorum for digital rights management.

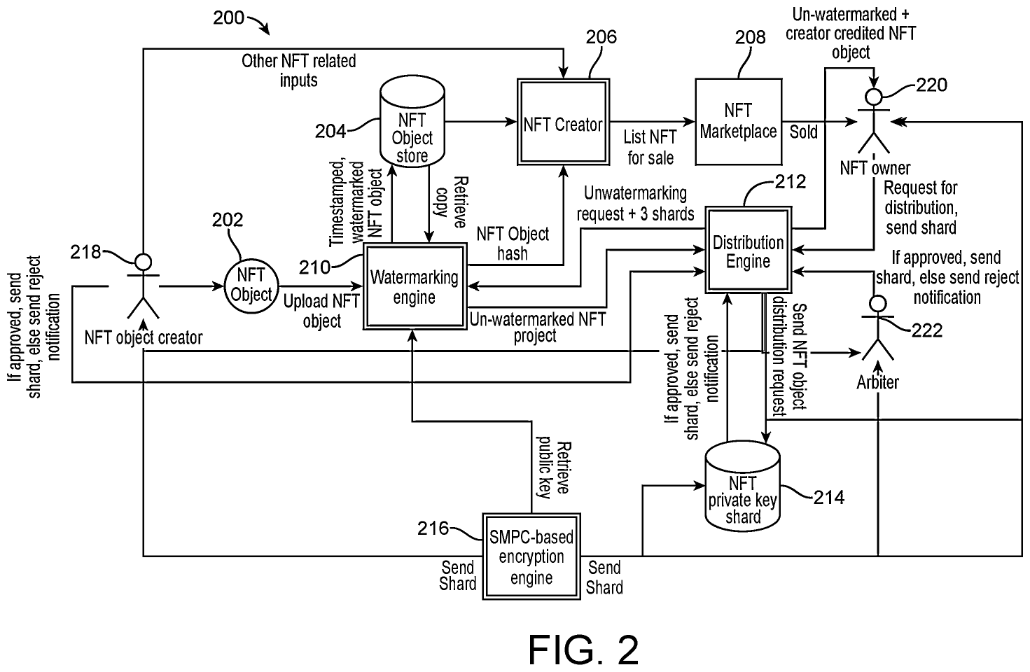

FIG. 2 is a diagram illustrating an example of a rights management system 200, in accordance with certain aspects of the present disclosure. In one illustrative example, the rights management system 200 may include an encryption engine 216 (e.g., a secure multiparty computation (SMPC)-based encryption engine), a watermarking engine 210, a distribution engine 212 and an NFT generator 206 (also referred to as an NFT creator).

The encryption engine 216 may use secure MPC and/or threshold signature schemes to generate asymmetric keys (e.g., including one or more public keys and one or more private keys). A public key of an asymmetric key pair can be used to encrypt any number of NFT object bits without compromising the quality of the object (e.g., using a watermarking scheme). The private key is used to decrypt the encrypted NFT object bits.

In some aspects of the present disclosure, the private key of the asymmetric key pair can be split into a number of shards (e.g., four shards). In the example of four shards, one shard may be retained on the NFT platform (e.g., the platform hosting the NFT), the second shard may be given to the NFT object creator 218, the third shard may be given to the NFT owner 220, and the fourth shard may be given to an arbiter 222. In such an example, at any given point, at least three shards (of the four shards) may be required to decrypt the bits of the NFT object. In other words, the private key may be split into four shards in a manner that only three of the shards are necessary to generate the private key.

The watermarking engine 210 may receive an NFT object 202 from the object creator 218 to watermark. Upon receiving the NFT object 202 from the object creator 218 to watermark, the watermarking engine 210 may retrieve the corresponding public key from the encryption engine 216 for watermarking, as shown. Once the watermarking is complete, the watermarking engine 210 can timestamp the NFT object 202. The watermarking engine 210 may encrypt the timestamp using the retrieved public key, in some aspects. The watermarking engine 210 may embed the encrypted timestamp into the metadata of the NFT object 202, in some implementations.

The resulting watermarked and timestamped NFT object may be stored in a secure database 204 (e.g., NFT object store) using a resulting hash/checksum of the NFT object as a reference key. The resulting hash/checksum of the NFT object can also be sent to the NFT generator 206 to create the NFT. As shown, the NFT generator 206 may list the NFT for sale on an NFT marketplace 208, which may be sold to an NFT owner 220. In some aspects, the hash/checksum may be used to verify the authenticity of the NFT object and to ensure that it has not been altered within the database 204. In some cases, the hash/checksum may be used to look up the NFT object in the database 204. At this point, the NFT object is deemed unique and authentic.

When the watermarking engine 210 receives an instruction to un-watermark the NFT object, the watermarking engine 210 may retrieve a copy of the NFT object from the database 204 and decrypt the timestamp and the NFT object bits using the shards (e.g., three shards out of the four total shards, as described). In some aspects, to unwatermark the NFT object, the watermarking engine 210 may receive the shards from the distribution engine 212. The distribution engine 212 may be configured to gather the shards from the various entities for unwatermarking, as described in more detail herein. The watermarking engine 210 can remove the timestamp from the NTF object metadata and send the resulting NFT object to the distribution engine 212.

The distribution engine 212 may be evoked (e.g., to gather the shards) when the NFT owner 220 invokes distribution rights encoded in the NFT contract. The distribution rights may include any right to use the copyrighted object (e.g., make copies of the object or image, or download the object or image). The distribution engine 212 may output a notification to the shard owners regarding removing the watermark on the NFT object. Suppose the required number of shard holders (e.g., three of the four shard holders in the example from above) acknowledge and approve the reversal of the watermark and the distribution of the NFT object by sending their shards to the distribution engine 212. In that case, the unwatermarking of the NFT object may occur. For instance, each shard holder may either reject the unwatermarking (e.g., by not sending the shard and/or sending a reject notification back to the distribution engine 212) or approve the unwatermarking by sending their shard. In the example of three shards of four total shards being required, the distribution engine 212 may receive three shards and send the three shards to the watermarking engine 210 to unwatermark the NFT object. Once distribution engine 212 receives the unwatermarked NFT object from the watermarking engine 210, the distribution engine 212 may retrieve the NFT object creator credits included in the metadata file of the NFT, and can add the credits to the NFT object. The resulting object can then be made available for download or otherwise for access by the NFT owner 220 for some time (e.g., as determined in the distribution rights).

In some aspects, NFT generator 206 may receive the NFT object hash/checksum from the watermarking engine 210 to be used as part of the NFT ID and may create or generate an NFT for the NFT object based on other inputs provided by the NFT object owner 220. In some examples, these inputs may include various NFTs to be created or distribution rights.

In some aspects of the present disclosure, the NFT object creator 218 may upload the NFT object to the platform or system. The watermarking engine 210 is invoked to cryptographically watermark the NFT object, as described. Once complete, the NFT object is stored in the database 204 using its hash/checksum as a reference key and made available to the NFT generator 206 to create the corresponding NFT for sale on marketplace 208. Once the NFT is created, the corresponding private key shards (e.g., four total shards) are distributed to the owner and the arbiter, where the platform retains two shards (e.g., stored in database 214) until the sale of the NFT. Once the NFT is sold, one of the two shards retained by the platform is provided to the NFT owner 220.

When the NFT owner 220 invokes their distribution rights, the distribution engine 212 notifies the shard owners of the intent of the NFT owner 220. Three of the four shard holders approve and send their shards for un-watermarking. Once the distribution engine receives the un-watermarked NFT object, it processes the NFT object to include NFT object creator credits and makes it available for the NFT owner for distribution. The NFT owner may download the object and make as many copies as they desire and distribute the copy/copies accordingly. In some cases, at any point, the hash/checksum of the distributed copy of the NFT object (e.g., the NFT object without watermarking) and the hash/checksum of the NFT object in the database (e.g., the NFT object with watermarking) would not be the same, which allows the system to retain the uniqueness and authenticity of the genesis NFT object. In other words, when watermarking an image, certain bits of the image are encrypted. After watermarking, a hash/checksum of the image may be created for the image with watermarking. Therefore, the hash/checksum is different from the image's hash after unwatermarking for distribution.

Some aspects of the present disclosure are directed towards methods and systems for secure and high-fidelity storage for NFT assets using MPC. An NFT, being a blockchain-based digital asset, inherits immutability, transparency, and undisputed ownership properties from the blockchain from which it is created. However, the metadata file associated with the NFT and the objects they represent are mutable assets that do not typically reside on a blockchain. For example, these items are typically stored elsewhere in a database that is either centralized or distributed, self-owned or hosted by a service provider like. In some cases, the metadata file associated with the NFT and the objects they represent may reside on a blockchain, but it is currently expensive to do so.

While secure and robust storage solutions exist to safeguard NFT objects (e.g., digital assets or physical representation of digital assets) and its metadata file, they do not however preserve confidentiality. Confidentiality is a key aspect for safeguarding the value of the NFT and its value is tightly coupled to the provenance, scarcity, utility, and uniqueness of the NFT object that it represents. For instance, if the object or the metadata file is not kept confidential, an adversary who manages to access them could replicate the assets and distribute them at will, rendering the corresponding NFT worthless. Systems and techniques are described herein for providing a centralized, secure platform of databases and processes that securely stores NFT metadata files and corresponding NFT objects.

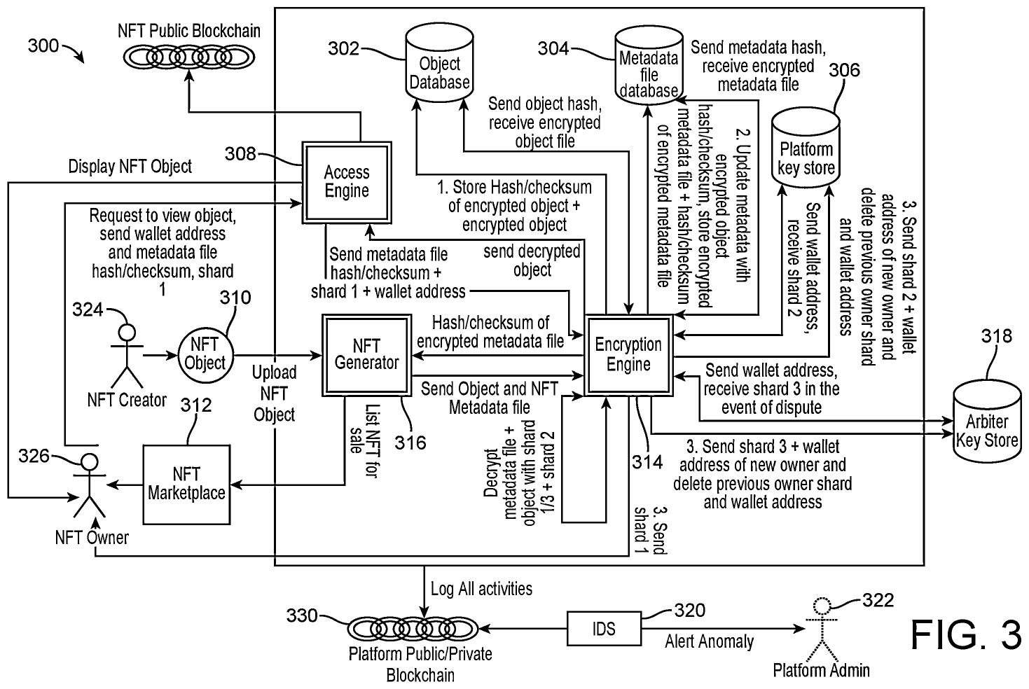

FIG. 3 is a diagram illustrating an example of a storage system 300 for secure and high-fidelity storage of NFT assets using multiparty computation (MPC), in accordance with certain aspects of the present disclosure. In one illustrative example, the storage system 300 may include, be associated with, or be in communication with a platform public/private blockchain 330, intrusion detection system (IDS) 320, and an encryption engine 314.

The platform public/private blockchain 330 is an immutable ledger system that records access to and activity on the platform (e.g., every access to and activity on the platform). The platform public/private blockchain 330 may record the NFT owner's ID, location, time of access, when the databases were accessed, among other information.

The IDS 320 monitors the blockchain (e.g., in real-time) for anomalies, such as unauthorized access. Any detected anomaly may be indicated to a platform administrator 322 to take action. The encryption engine 314 may generate asymmetric keys (e.g., including one or more public keys and one or more private keys), such as by using secure multiparty computation and/or threshold signature schemes to generate the asymmetric keys. A public key of an asymmetric key pair may be used to encrypt NFT object 310 from an NFT creator 324 and the NFT's metadata file. A private key of the asymmetric key pair may be used to decrypt the encrypted NFT object and the metadata file of the NFT. The private key of the asymmetric key pair can be split into a number of shards (e.g., three shards). In the example of three shards, the first shard can be given to the NFT owner 326, the second shard may be retained on the platform (e.g., stored in the platform key store 306), and the third shard may be given to an arbiter and stored in an arbiter key store 318. In such an example, at any given point, at least two shards may be required to decrypt the NFT object and metadata file. All computations in the encryption engine 314 happen in a secure enclave.

In some aspects, the access engine 308 may receive, from the NFT owner 326, a request to view an object (e.g., along with wallet address, hash/checksum of the metadata file, and the associated shard). In turn, the encryption engine 314 may receive a request from access engine 308 for a decrypted object file. Upon receiving the request from the access engine 308 for the decrypted object file, the encryption engine 314 can use the hash/checksum of the metadata file sent by the access engine 308 to obtain the encrypted metadata file from the NFT metadata file database 304. The encryption engine 314 may then request the second shard of the private key from the platform key store 306 and may decrypt the metadata file using the first shard received from the access engine 308 (e.g., shard from NFT owner 326) and the second shard from the platform key store 306. The encryption engine 314 can then extract from the NFT object database 302 the hash/checksum of the NFT object, request the encrypted object from the NFT object database 302, and use the first and second shards of the private key to decrypt the NFT object. The encryption engine 314 may then send the decrypted NFT object to the access engine 308, such as to display to the owner 326, as shown.

In the event the NFT is sold to a new owner, the encryption engine 314 may receive a notification from the access engine 308 regarding the sale to the new owner. Using the first shard of the private key provided by the access engine 308 and the second shard of the private key from the platform key store 306, the encryption engine 314 may decrypt the metadata file, extract the hash/checksum of the NFT object from the object database 302, retrieve the object from the object database 302, and decrypt the object using the first shard and the second shard. In some cases, once the object is decrypted, the encryption engine may discard the shards. In some aspects, the encryption engine 314 may then create new public and private keys. The encryption engine 314 may use the new public key to encrypt the object, create the hash/checksum of the encrypted object, and update the database 302 with the newly encrypted object and the associated hash/checksum. The encryption engine 314 may then update the metadata file with the new object hash/check. The encryption engine 314 may encrypt the metadata file with the public key and update the metadata file database 304 with the newly encrypted metadata file. In some cases, the hash/checksum may not be calculated as the universal resource identifier (URI) of the NFT cannot be changed. The encryption engine 314 may create new shards (e.g., three new shards) of the private key, send the first new shard to the new NFT owner and can update the platform key store 306 with the second new shard and the new owner wallet address. The encryption engine 314 may remove the previous owner wallet address and the second shard. The encryption engine 314 may then update the arbiter key store 318 with the new third shard and the new owner wallet address and delete the previous owner wallet address and the previous third shard.

The NFT object database 302 may store the encrypted NFT object and the corresponding hash/checksum, which may be used as a reference to the encrypted NFT object in the database 302. The NFT metadata file database 304 may store the encrypted NFT metadata file and the corresponding hash/checksum, which may be used to reference the encrypted NFT metadata file in database 304.

In some aspects, the access engine 308 may authenticate the NFT owner based on the provided wallet address and may verify the address against the NFT blockchain. The access engine 308 may send the first shard and the metadata file hash/checksum to the encryption engine. In the event the NFT is sold to a new owner, the access engine 308 may notify the encryption engine 314 of the sale along with the previous owner's wallet address, previous owner's shard, and the new owner's wallet address.

In the example of three shards per private key, the platform key store 306 may store the second shard of the private key and the NFT owner's wallet address. As described, the second shard may be used by the encryption engine 314 to decrypt the NFT metadata file and object along with the first shard of the three shards.

In the example of three shards per private key, the arbiter key store 318 may store the third shard of the private key and the NFT owner's wallet address. As described, the third shard may be used by the encryption engine 314 to decrypt the NFT metadata file and object along with the first shard.

Once the NFT creator 324 uploads the NFT object, the object is sent to the encryption engine 314 by the NFT generator 316. The NFT generator 316 may send the object file and the metadata file to the encryption engine 314. Upon receiving the hash/checksum of the metadata file from the encryption engine 314, the NFT generator 316 may include the hash/checksum of the metadata file as part of the NFT URI and may create the NFT with a unique ID. The NFT generator 316 may list the NFT for sale in an NFT marketplace 312. The NFT marketplace 312 is a platform where NFTs are sold and bought.

In certain aspects of the present disclosure, when the NFT creator 324 uploads the NFT object 310, the object 310 is encrypted using the public key and the resulting encrypted object's hash/checksum is calculated. The resulting hash/checksum of the object, along with the encrypted object, is inserted into the NFT object's database 302. The resulting object's hash/checksum is also inserted into the NFT metadata file. The NFT metadata file is then encrypted using the same public key, a hash/checksum is calculated, and the resulting hash/checksum is inserted into the NFT metadata file database 304 along with the encrypted NFT metadata file. The NFT generator 316 receives the hash/checksum of the NFT metadata file from the encryption engine 314. The NFT generator 316 can then include this hash/checksum in the NFT uniform resource identifier (URI) and create the NFT. The NFT generator 316 may then list the NFT in the marketplace for sale.

In the event a sale of the NFT occurs, the private key shard one of three shards associated with decryption of the NFT object and NFT metadata file is sent to the NFT owner 326. The owner's wallet address is inserted into the platform key store 306 and arbiter key store 318, along with shard two and shard three, respectively. When the NFT owner 326 wants to access the NFT object, a request including the NFT owner's wallet address, shard one, and hash/checksum of NFT metadata file is sent to the access engine 308. The access engine 308 authenticates the NFT owner 326 using the owner's wallet address and the NFT blockchain. The access engine 308 may then send a request to the encryption engine 314 along with shard one and hash/checksum of the encrypted metadata file for the decrypted object file. Based on the request, the encryption engine 314 may decrypt the object file and sends it back to access engine 308 to display the object to the NFT owner 326, as described.

When the NFT changes hands via sale and resale, the public key and the corresponding private key shards may be discarded and new ones may be created, as described herein. The arbiter key store 318 and the platform key store 306 may also be updated with the new owner's wallet address and corresponding shards. In some aspects, access and activities on the platform are logged onto the blockchain and any anomaly is detected in real-time and reported to the platform admin 322.

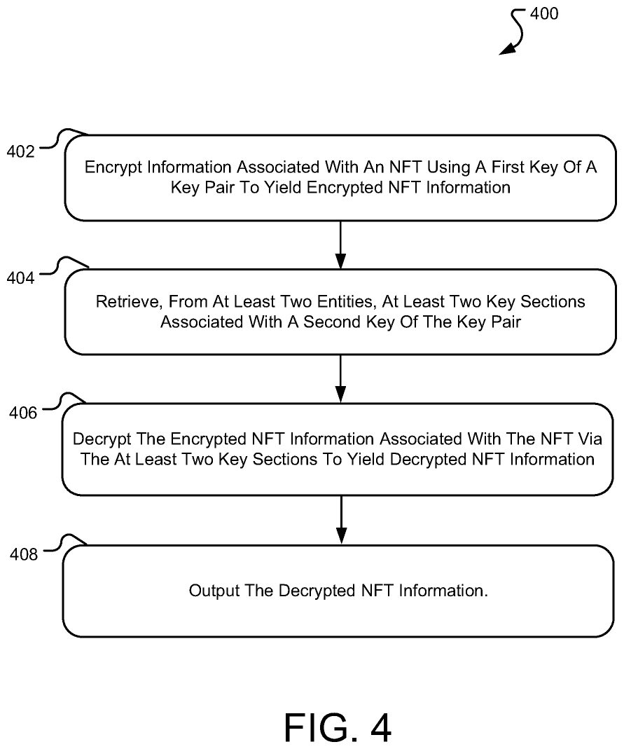

FIG. 4 illustrates example operations 400 for NFT processing, in accordance with certain aspects of the present disclosure. The operations 400 may be performed, for example, by an NFT system such as a processor (e.g., processor 1010), and in some aspects, a memory (e.g., storage device 1030).

At block 402, the NFT system encrypts information associated with an NFT using a first key (e.g., a public key) of a key pair to yield encrypted NFT information. In some aspects, encrypting the information associated with the NFT includes encrypting an object associated with the NFT. For example, encrypting the object associated with the NFT may include watermarking (e.g., via watermarking engine 210) an NFT object (e.g., NFT object 202) using the first key of the key pair. Decrypting the encrypted NFT information may include unwatermarking (e.g., via watermarking engine 210) the watermarked NFT object via the at least two key sections. In some aspects, watermarking an image (e.g., NFT object) may involve adding a background image to the image and unwatermarking the image may involve remove the background image.

In some aspects, the encrypted NFT information may include encrypted metadata associated with the NFT (e.g., as described with respect to FIG. 3). The NFT system may receive, in response to a request to view an object associated with the NFT, identifying information (e.g., a hash function or checksum) associated with the encrypted NFT information. The NFT system may retrieve the encrypted NFT information from a database (e.g., metadata file database 304 described with respect to FIG. 3) based on the identifying information.

In some aspects, the NFT system may encrypt an object associated with the NFT (e.g., to be stored in object database 302 described with respect to FIG. 3). The encrypted metadata may include a hash function or checksum corresponding to the encrypted object.

At block 404, the NFT system retrieves, from at least two entities, at least two key sections associated with a second key of the key pair. In some aspects, the NFT system may generate (e.g., via encryption engine 216 described with respect to FIG. 2 or encryption engine 314 described with respect to FIG. 3) the at least two key sections associated with the second key (e.g., a private key) of the key pair using multiparty computation (MPC). The NFT system may send the at least two key sections to the at least two entities (e.g., at least two of an NFT owner, NFT creator, arbiter, or a platform database such as database 214). For instance, generating the at least two key sections may include generating at least three key sections (e.g., four key sections as described with respect to FIG. 2). Only a subset of the at least three key sections may be required to decrypt the encrypted NFT information, in some aspects.

In some aspects, the at least two key sections may include a first key section retrieved from a creator of the NFT (e.g., creator 218 as described with respect to FIG. 2). The at least two key sections may also include a second key section retrieved from an owner of the NFT (e.g., NFT owner 220), and a third key section retrieved from an arbiter (e.g., arbiter 222).

In some aspects, the at least two key sections include a first key section retrieved from a platform database (e.g., platform key store 306 described with respect to FIG. 3) and a second key section retrieved from an owner of the NFT (e.g., NFT owner 326 described with respect to FIG. 3).

At block 406, the NFT system decrypts the encrypted NFT information associated with the NFT via the at least two key sections to yield decrypted NFT information. In some aspects, decrypting the encrypted NFT information may be in response to a request for distribution of the NFT (e.g., from distribution engine 212 as described with respect to FIG. 2). At block 408, the NFT system outputs the decrypted NFT information.

Some aspects of the present disclosure are directed towards a credit display mechanism for NFT objects. An NFT may be a smart contract that points to a metadata file (e.g., by providing a link to an object, such as a digital object or a digital representation of a physical object) that includes information about supply, authenticity, creator credits, provenance, and/or other information of the object. However, NFT metadata is a separate file that may or may not reside on the blockchain and requires special means and tools to display the contents of the NFT. Even when NFT objects are displayed in one or more virtual worlds or distributed in the real world, the information (e.g., supply, credits, authenticity, provenance, etc. of the NFT object) is often omitted from display and distribution. Systems and techniques are described herein for displaying additional contents of an NFT metadata file associated with an object (e.g., a digital object or a digital representation of a physical object).

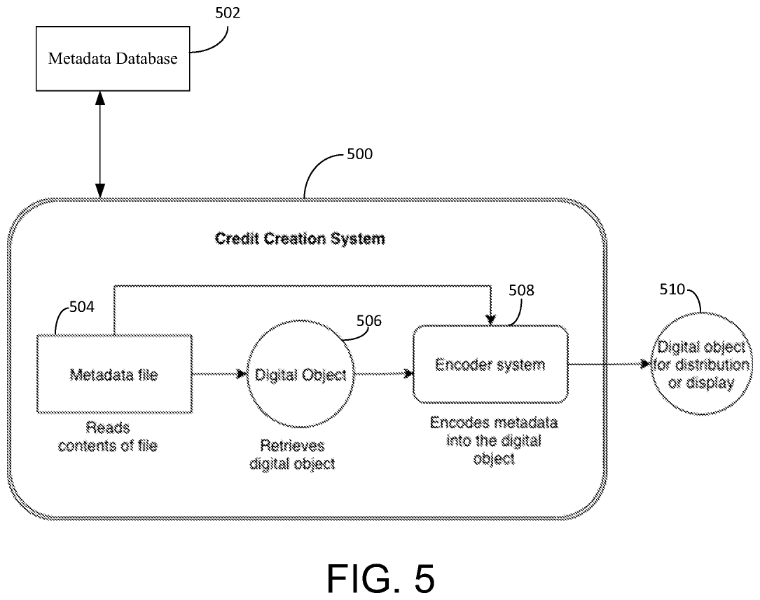

FIG. 5 is a block diagram illustrating a credit creation system 500, in accordance with certain aspects of the present disclosure. When an owner of an NFT chooses to download and distribute and/or display a digital object associated with the NFT in a virtual world, on the Internet, or otherwise distribute the digital object associated with the NFT, the credit creation system 500 may retrieve the relevant information (e.g., the supply, credits, authenticity, and provenance of the NFT object) from a metadata file 504 of the NFT. The information may be retrieved from a metadata database 502. The credit creation system 500 may encode the data into the digital object 506 representing the NFT such that the data is not visible to the naked eye of any users. For instance, the credit creation system 500 may encode the data into the digital object 506 so that the encoded data will be visible to anyone using decoder digital filters or glasses.

The credit creation system 500 may retrieve relevant data from the metadata file 504. The credit creation system 500 may also retrieve the digital object 506 associated with the metadata file 504. The credit creation system 500 may then encode data into the digital object 506 via the encoder system 508 to yield an encoded object 510. The encoded object may be displayed or distributed.

In some aspects, the data may be encoded in the object in a manner that the encoded object is visually the same as the original object prior to encoding. Using an image as an illustrative example of an object associated with an NFT, the encoder system 508 may encode the data into the digital object 506 by identifying the prominent or dominant color in the image and embedding the data into the dominant color space in a manner that is not visible to the naked eye. Once encoded, digital object 506 is ready to be displayed and/or distributed by the system (e.g., based on user input, such as input from the content creator and/or NFT owner).

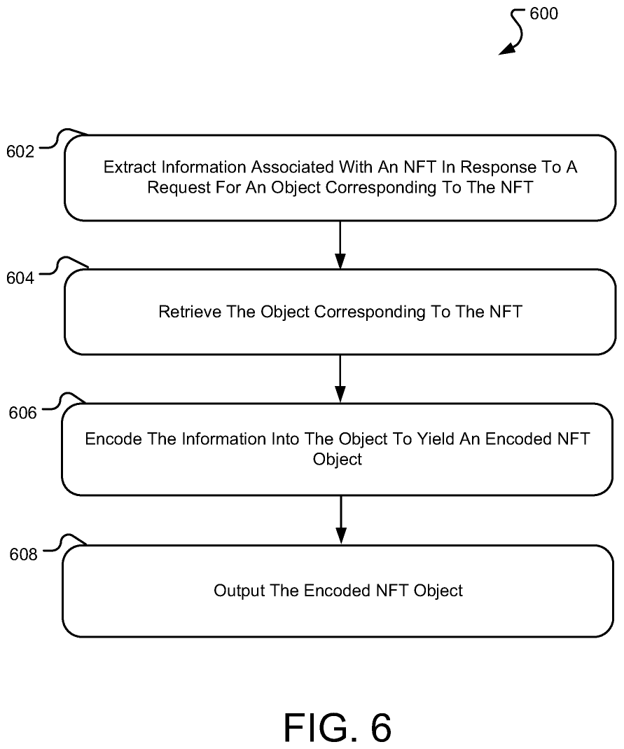

FIG. 6 illustrates example operations 600 for NFT processing, in accordance with certain aspects of the present disclosure. The operations 600 may be performed, for example, by an NFT system (e.g., credit creation system 500) such as a processor (e.g., processor 1010), and in some aspects, a memory (e.g., storage device 1030).

At block 602, the NFT system extracts information associated with an NFT in response to a request for an object (e.g., image) corresponding to the NFT. The information associated with the NFT may include information associated with a creator of the object. The information associated with the NFT may include metadata of the object.

At block 604, the NFT system retrieves the object corresponding to the NFT. At block 606, the NFT system encodes the information into the object to yield an encoded NFT object. In some aspects, the object may be an image. The information may be encoded based on a dominant color associated with the image. The encoded NFT object is visually the same as the object prior to encoding the information into the object. At block 608, the NFT system outputs the encoded NFT object.

Some aspects of the present disclosure are directed toward content moderation for NFT objects. There is a lack of effective manual or automated content moderation for NFT digital objects. For example, digital objects against which NFTs are created are not moderated for their content. NFTs are sold on the free market with little regard to the legality and/or restrictions regarding the sale, purchase, and possession of certain content. Such a lack of moderation can be problematic. For instance, regulatory bodies around the world, from time to time, may restrict the sale, purchase, possession, and/or other handling of certain digital content (e.g., photos, videos, texts, software, etc.). Such restrictions may cause legal issues, may evoke negative emotions, and/or have unintended societal implications. Digital content moderation is often manual, difficult, and context-sensitive. Existing content moderation tools and techniques also do not account for the likes of malicious software. Systems and techniques are described herein that provide a platform or system (e.g., an online machine learning or artificial intelligent (AI)-based platform or system) that screens and monitors user-generated content (e.g., one or more images, videos, memorabilia, literature, and/or other type of content) based on platform-specific rules and guidelines to determine if an NFT should be created, distributed, offered for sale, or displayed in a particular geographical area.

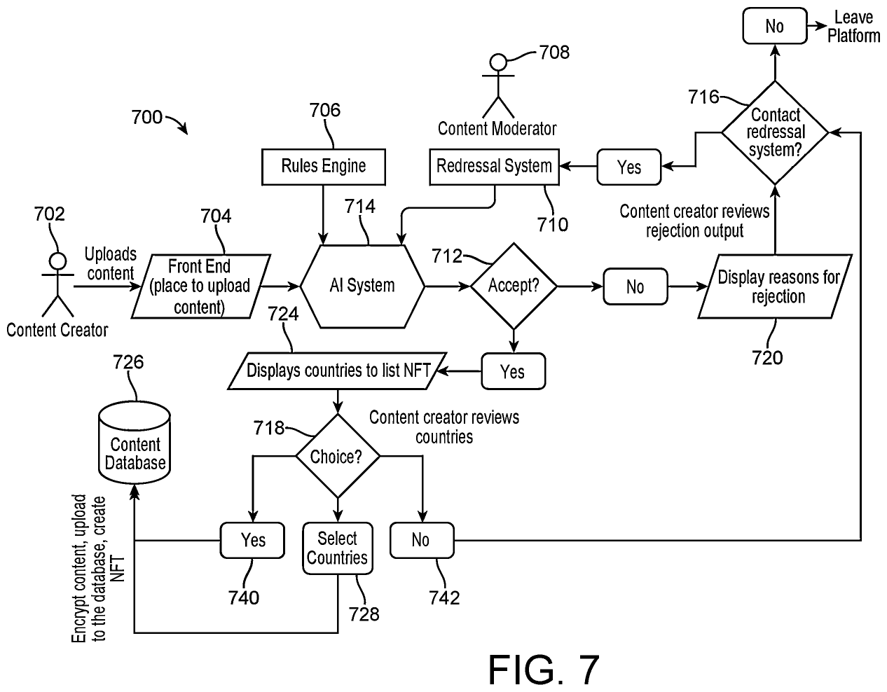

FIG. 7 is a block diagram illustrating an example content moderation system 700, in accordance with certain aspects of the present disclosure. As shown, the content moderation system 700 may include an artificial intelligence (AI) system 714, a rules engine 706, and a redressal system 710. The AI system 714 may periodically or continuously learn (and thus be trained, such as by tuning weights, biases, and/or other parameters of the AI system) from user input and the rules engine to determine if content is acceptable or not for NFT processing. In some cases, if the AI system 714 determines that an item of content is acceptable for NFT processing, the AI system may determine one or more countries where the NFT can be listed for sale. In some aspects, the AI system 714 may include one or more neural networks or other type of machine-learning based system.

The rules engine 706 includes rules that are used by AI system 714 to determine whether or not digital content is acceptable for NFT processing. In some examples, the rules engine 706 may include country-specific digital content and digital asset rules and regulations. For example, certain content may not be sold in some geographical regions. For instance, in may be against the law to display a picture of a certain cartoon character in some countries. The rules engine 706 may include rules with regard to which content can be displayed in what geographical areas. The AI system 714 may identify a characteristic of content from the content creator 702 (e.g., using image recognition), and in accordance with the rules from the rules engine 706, determine whether the content may be sold in various geographical areas. In some cases, the rules engine may also include rules for the detection of malicious software.

The redressal system 710 may provide an interface for a content creator to receive further context. For example, content creator 702 may interact with (e.g., using a graphical user interface) the redressal system 710 for manual review of content and to provide additional context if available. The AI system may use the additional context to determine whether the associated NFT can be processed. The output of the redressal system 710 can be provided to the AI system and used as input to improve the AI system.

As shown, the content creator 702 may upload digital content to the platform using a front-end interface 704. The AI system 714 may scan the content and determine whether or not the content is acceptable for NFT processing at block 712. If accepted, the AI system 714 may determine any specific geographical areas (e.g., country/countries) where the sale of the content is acceptable and at block 724, display the geographical areas to the content creator 702. At block 718, the content creator 702 may review the geographical areas and accept the output as-is at block 740, may choose (e.g., by providing input via the graphical user interface) specific countries from the provided list for listing of one or more NFTs for the digital content for sale at block 728, or may reject (e.g., by providing input via the graphical user interface) the listing altogether at block 742. If the creator 702 chooses to list one or more NFTs, the content creator 702 may provide (e.g., by providing input via the graphical user interface) other relevant information for NFT creation. The system may then encrypt the content, upload the content to a content database 726, and create one or more corresponding NFTs.

In the event the AI system 714 rejects the content for NFT processing at block 712, the AI system 714 may provide an output to the creator (e.g., by displaying information or otherwise outputting information) with reasons for rejection at block 720. At block 716, the content creator 702 may choose to interact with the redressal system 710 (e.g., by providing an input via the graphical user interface) to request further clarification such as information providing clarity regarding the context of the content, provide additional context, or to have the content manually reviewed for acceptance. In the event the content creator 702 provides a request to the redressal system for further review, a manual review of the content may be performed (e.g., by an administrator 708 of the system). The system can feed back the outcome of the review into the AI system 714, as shown.

In some aspects of the present disclosure, the content moderation system 700 may identify information about the content creator and validate the identity of the content creator. The AI system may consider this information to determine whether to allow NFT creation and sale in a particular geographical region. For instance, the AI system may determine whether the creator is trusted not to violate any digital content copyright or other restrictions of the content for which they choose to create an NFT.

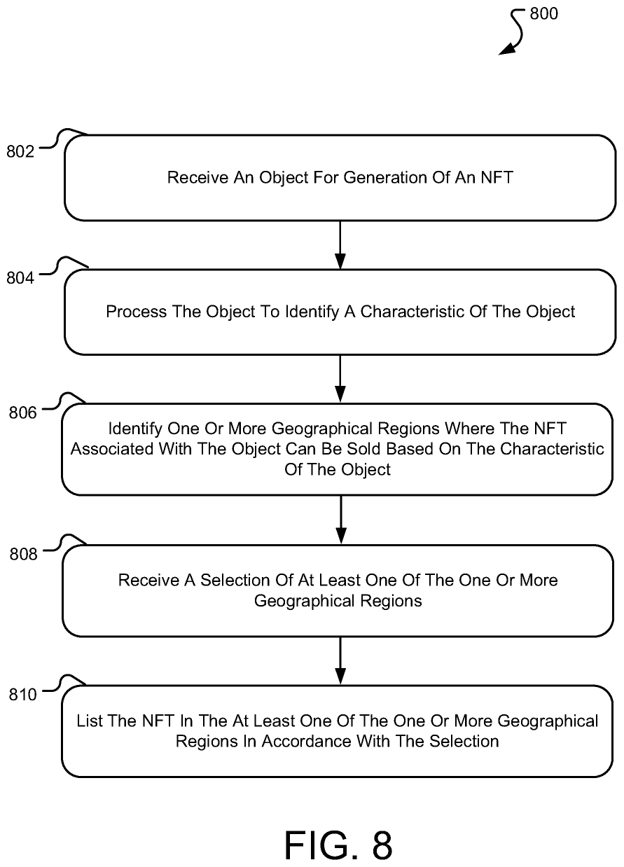

FIG. 8 illustrates example operations 800 for NFT processing, in accordance with certain aspects of the present disclosure. The operations 800 may be performed, for example, by an NFT system (e.g., credit creation system 500) such as a processor (e.g., processor 1010), and in some aspects, a memory (e.g., storage device 1030).

At block 802, the NFT system (e.g., AI system 714) receives an object for generation of an NFT. At block 804, the NFT system processes the object to identify a characteristic of the object. Processing the object to identify the characteristic of the object may include identifying a type of content associated with the object. For example, the object may be an image, and the type of content associated with the image may be identified using image recognition.

At block 806, the NFT system identifies one or more geographical regions where the NFT associated with the object can be sold based on the characteristic of the object. In some aspects, the one or more geographical regions may be identified based on one or more rules from a rules engine (e.g., rules engine 706). The one or more geographical regions include one or more countries or counties. For instance, identifying the one or more geographical regions may include identifying whether one or more regulations associated with the one or more geographical regions allows sale or display of the type of content.

At block 808, the NFT system receives (e.g., from content creator 702) a selection of at least one of the one or more geographical regions. At block 810, the NFT system lists the NFT in the at least one of the one or more geographical regions in accordance with the selection.

Certain aspects of the present disclosure provide systems and techniques for management of crowd funding (e.g., angel investing). While example techniques are described herein with respect to angel investing as one example of crowd funding to facilitate understanding, the aspects described herein may be applied to crowd funding in general.

Angel investing is a speculative venture with associated risks. The risk associated with angel investing is typically digestible to only large institutional investors who have the monetary means to fund such ventures. Other investors with less monetary resources often lose out on angel investing opportunities or are highly restricted from participating in these ventures. Systems and techniques are described herein that allow individual investors to invest in a company in the early stages while at the same time giving them a collectable NFT.

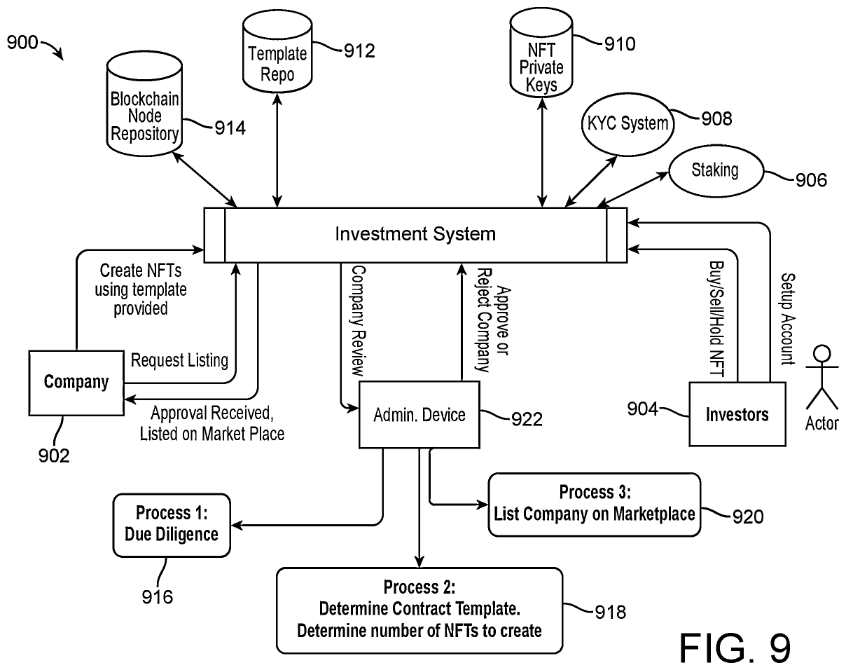

FIG. 9 is a block diagram illustrating an investment system 900, in accordance with certain aspects of the present disclosure. As described, angel investing (or crowd funding in general) is often reserved for specific companies (e.g., institutional investors or those associated with institutional investors) and specific amounts of money that often make it difficult for the average person to participate. With investment system 900, power of investing and funding is brought to smaller companies and individuals without a high entry price. For instance, a company can select a number of investors they are targeting as well as a minimum entry cost. In the future, as the company grows, the investment pays out a percentage.

Investment system 900 may allow various investors to fund early-stage startup companies, products, etc. through crowdfunding. For example, a company 902 may be interested in launching a product, and may solicit potential investors 904. An investor that invests in the product may receive a unique NFT that is matched to the product they purchase, providing a kind of certificate of authenticity as well as a collectable.

For an investor in a company or product, the NFT also provides bragging rights. In one example, a digital display case available at a custom location (e.g., a website via a custom uniform resource identifier (URI)) can display NFTs, their unique serial numbers, and the extent of the person's investment in the company or product. Investment system 900 allows anyone to become an investor. Investment system 900 provides a unique, safe, secure, indisputable space or a secondary market for companies to raise money from anywhere in the world and for investors of all calibers to invest in the growth of a company and earn passive income as a result.

In some aspects, investment system 900 may be implemented as a distributed platform built on top of a proof-of-stake, contract-enabled blockchain. In some aspects, the investment system 900 may include a custody database 910, which may include a hardware-based crypto key storage solution (and in some cases a software-based storage) to store the private keys of NFTs. The investment system may include a contract template repository 912. Templates may have hardcoded conditions against which the NFTs will be created and produced for sale by a company seeking funding. A contract template can be chosen by a user (e.g., by an administrator of the platform via an administrator device 922) based on due diligence of the company (e.g., performed at block 916) and their funding requirements. At block 918, administrator may determine (e.g., by providing input via an administrator device 922) the contract template and how many NFTs may be created, licensing details, unique identifier(s), and other timestamped details to determine the uniqueness and originality of the NFT. At block 920, the administrator may list the company on the marketplace for investment accordingly. The NFT marketplace is a peer-to-peer marketplace where investors can trade (buy and sell) the NFTs they already possess. The investors can also participate in the bidding process set up by other investors on the platform. The investment system 900 may also include a blockchain node repository 914, which is a collection of different blockchain nodes that support NFT creation and sale using smart contracts.

The NFTs themselves may have unique URIs that point to a virtual space (which may be referred to as a digital display case) where investors can display their trophies (e.g., tokens, their unique serial numbers, and the extent of the person's investing). The investment system 900 may also include a know-your-client (KYC) system 908, which may verify companies and investors who participate in the sale and purchase of NFTs. For instance, a user may enter information (e.g., username, password, driver's license information, social security number, etc.) that allows the KYC system 908 to verify the user as an investor in a company. In another example, company 902 may enter the company's identifying information so that the KYC system can verify the company.

The staking engine 906 may allow investors to earn passive income on the NFTs they hold in their portfolio. The passive income may be earned by staking the NFTs against a blockchain or by charging a nominal amount to other investors who would want to view their NFT collection/portfolio in the virtual space (e.g., the digital display case).

As noted above, an NFT can be associated with a URI that identifies a location in a virtual display case (as an example of a virtual space) to, for example, display information associated with an investor's portfolio of NFTs to other investors or companies on the platform. The virtual display case may provide a virtual walkthrough experience of the NFTs an investor holds. In some cases, the virtual display case is privately owned and can be restricted to others. The virtual space owner can charge others a nominal amount for viewing their portfolio, giving a museum-like experience to other users. In some cases, multiple virtual display cases can be created, with one or more of the virtual display cases being owned by multiple users.

In some aspects, a fail-safe feature may be provided, where access to the platform may be set up so that multiple parties can access the account in the event of the death of the original investor. The mechanism is achieved by using secure multi-party-computation to generate at least 3 shards of an access key (unique to every investor). Of the 3 shards, one rests with the platform, one with the initiating or original investor, and the third shard with a trusted party of the initiating or original investor. At least two of the shards may be necessary to access an account.

As described, administrator may perform due diligence on the companies that initiate a process to be listed with the platform to raise money through crowdfunding. The administrator may approve or decline the company by using a graphical user interface. On approval, the administrator can determine and provide recommended contract templates to the company for NFT creation and may determine or recommend the amount of NFTs to be created. Administrator may then facilitate the listing of the company on the marketplace, such as by providing one or more inputs via the administrator device 922. In some cases, administrator may receive a commission from the company for providing the service. The administrator may in some cases receive a commission from the investors for providing sale, purchase, and hold services of the NFTs.

The user or investor may include a person or a group or “body of persons” interested in funding the company and have the ability to buy NFTs at slated prices. As described, investors may be required to pay a certain amount of commission to the administrator for the services provided on the platform. In some examples, the investment system 900 may provide an interface to allow investors to participate in a peer-to-peer marketplace to sell their NFTs or buy NFTs from other investors. In some aspects, the investment system 900 may provide an interface to allow investors to participate and/or bid for NFTs in the marketplace.

The company can be an institution seeking to raise funds. The company can submit a request (e.g., using a graphical user interface) to the administrator for one or more NFTs to be listed in the marketplace and, upon approval by the administrator, create or select one or more NFTs (e.g., by selecting, via a graphical user interface) recommended by the administrator. The company or the administrator can then (e.g., via a graphical user interface) put the NFT(s) up for sale in the marketplace. The company can use the proceeds of the sale to fund the organizational expenses and provide unique physical memorabilia (e.g., a product of the company) to the investor. In some cases, the company, with growth, can pay out dividends to its investors (owners of its NFTs), such as on a regular basis. In some examples, the company can also offer to repurchase the tokens from the investors at a later point in time. In some aspects, even in the event the company ceases the exist, the NFTs continue to exist as memorabilia.

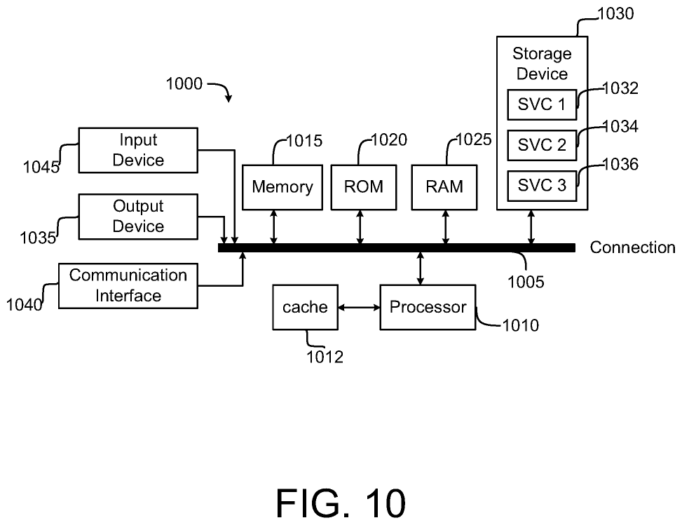

FIG. 10 illustrates an architecture of a computing system 1000 wherein the components of the system 1000 are in electrical communication with each other using a connection 1005, such as a bus. Exemplary system 1000 includes a processing unit (CPU or processor) 1010 and a system connection 1005 that couples various system components including the system memory 1015, such as read only memory (ROM) 1020 and random access memory (RAM) 1025, to the processor 1010. The system 1000 can include a cache of high-speed memory connected directly with, in close proximity to, or integrated as part of the processor 1010. The system 1000 can copy data from the memory 1015 and/or the storage device 1030 to the cache 1012 for quick access by the processor 1010. In this way, the cache can provide a performance boost that avoids processor 1010 delays while waiting for data. These and other modules can control or be configured to control the processor 1010 to perform various actions. Other system memory 1015 may be available for use as well. The memory 1015 can include multiple different types of memory with different performance characteristics. The processor 1010 can include any general purpose processor and a hardware or software service, such as service 1 1032, service 2 1034, and service 3 1036 stored in storage device 1030, configured to control the processor 1010 as well as a special-purpose processor where software instructions are incorporated into the actual processor design. The processor 1010 may be a completely self-contained computing system, containing multiple cores or processors, a bus, memory controller, cache, etc. A multi-core processor may be symmetric or asymmetric.

To enable client interaction with the computing system 1000, an input device 1045 can represent any number of input mechanisms, such as a microphone for speech, a touch-sensitive screen for gesture or graphical input, keyboard, mouse, motion input, speech and so forth. An output device 1035 can also be one or more of a number of output mechanisms known to those of skill in the art. In some instances, multimodal systems can enable a client to provide multiple types of input to communicate with the computing system 1000. The communications interface 1040 can generally govern and manage the client input and system output. There is no restriction on operating on any particular hardware arrangement and therefore the basic features here may easily be substituted for improved hardware or firmware arrangements as they are developed.

Storage device 1030 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1025, read only memory (ROM) 1020, and hybrids thereof.

The storage device 1030 can include services 1032, 1034, 1036 for controlling the processor 1010. Other hardware or software modules are contemplated. The storage device 1030 can be connected to the system connection 1005. In one aspect, a hardware module that performs a particular function can include the software component stored in a computer-readable medium in connection with the necessary hardware components, such as the processor 1010, connection 1005, output device 1035, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.

### Example Aspects

Clause 1. A method for non-fungible token (NFT) processing, comprising: encrypting information associated with an NFT using a first key of a key pair to yield encrypted NFT information; retrieving, from at least two entities, at least two key sections associated with a second key of the key pair; decrypting the encrypted NFT information associated with the NFT via the at least two key sections to yield decrypted NFT information; and outputting the decrypted NFT information.
Clause 2. The method of clause 1, wherein encrypting the information associated with the NFT includes encrypting an object associated with the NFT.
Clause 3. The method of clause 2, wherein: encrypting the object associated with the NFT includes watermarking an NFT object using the first key of the key pair; and decrypting the encrypted NFT information includes unwatermarking the watermarked NFT object via the at least two key sections.
Clause 4. The method of any one of clauses 1-3, further comprising: generating the at least two key sections associated with the second key of the key pair using multiparty computation (MPC); and sending the at least two key sections to the at least two entities.
Clause 5. The method of clause 4, wherein generating the at least two key sections includes generating at least three key sections, and wherein only a subset of the at least three key sections is required to decrypt the encrypted NFT information.
Clause 6. The method of any one of clauses 1-5, wherein decrypting the encrypted NFT information is in response to a request for distribution of the NFT.
Clause 7. The method of any one of clauses 1-6, wherein the at least two key sections include a first key section retrieved from a creator of the NFT.
Clause 8. The method of clause 7, wherein the at least two key sections further include: a second key section retrieved from an owner of the NFT; and a third key section retrieved from an arbiter.
Clause 9. The method of any one of clauses 1-8, wherein the encrypted NFT information includes encrypted metadata associated with the NFT.
Clause 10. The method of clause 9, further comprising: receiving, in response to a request to view an object associated with the NFT, identifying information associated with the encrypted NFT information; and retrieving the encrypted NFT information from a database based on the identifying information.
Clause 11. The method of clause 10, wherein the identifying information includes a hash function or a checksum associated with the encrypted NFT information.
Clause 12. The method of any one of clauses 9-11, further comprising: encrypting an object associated with the NFT, wherein the encrypted metadata includes a hash function or checksum corresponding to the encrypted object.
Clause 13. The method of any one of clauses 1-12, wherein the at least two key sections include: a first key section retrieved from a platform database; and a second key section retrieved from an owner of the NFT.
Clause 14. The method of any one of clauses 1-13, wherein the first key comprises a public key, and wherein the second key comprises a private key.
Clause 15. A method for non-fungible token (NFT) generation, comprising: receiving an object for generation of an NFT; processing the object to identify a characteristic of the object; identifying one or more geographical regions where the NFT associated with the object can be sold based on the characteristic of the object; receiving a selection of at least one of the one or more geographical regions; and listing the NFT in the at least one of the one or more geographical regions in accordance with the selection.
Clause 16. The method of clause 15, wherein the one or more geographical regions include one or more countries or counties.
Clause 17. The method of any one of clauses 15-16, wherein the processing the object to identify the characteristic of the object includes identifying a type of content associated with the object.
Clause 18. The method of clause 17, wherein the object includes an image, and wherein the type of content associated with the image is identified using image recognition.
Clause 19. The method of any one of clauses 17-18, wherein identifying the one or more geographical regions includes identifying whether one or more regulations associated with the one or more geographical regions allows sale or display of the type of content.
Clause 20. The method of any one of clauses 17-19, wherein the one or more geographical regions are identified based on one or more rules from a rules engine.
Clause 21. A method for non-fungible token (NFT) processing, comprising:
extracting information associated with an NFT in response to a request for an object corresponding to the NFT; retrieving the object corresponding to the NFT; encoding the information into the object to yield an encoded NFT object; and outputting the encoded NFT object.
Clause 22. The method of clause 21, wherein the information associated with the NFT includes information associated with a creator of the object.
Clause 23. The method of any one of clauses 21-22, wherein the information associated with the NFT includes metadata of the object.
Clause 24. The method of any one of clauses 21-23, wherein the object comprises an image.
Clause 25. The method of clause 24, wherein the information is encoded based on a dominant color associated with the image.
Clause 26. The method of any one of clauses 21-25, wherein the encoded NFT object is visually the same as the object prior to encoding the information into the object.
Clause 27. An apparatus for non-fungible token (NFT) processing, comprising: a memory; and one or more processors coupled to the memory, the one or more processors being configured to: encrypt information associated with an NFT using a first key of a key pair to yield encrypted NFT information; retrieve, from at least two entities, at least two key sections associated with a second key of the key pair; decrypt the encrypted NFT information associated with the NFT via the at least two key sections to yield decrypted NFT information; and output the decrypted NFT information.
Clause 28. The apparatus of clause 27, wherein, to encrypt the information associated with the NFT, the one or more processors are configured to encrypt an object associated with the NFT.
Clause 29. The apparatus of clause 28, wherein: to encrypt the object associated with the NFT, the one or more processors are configured to watermark an NFT object using the first key of the key pair; and to decrypt the encrypted NFT information, the one or more processors are configured to unwatermark the watermarked NFT object via the at least two key sections.
Clause 30. The apparatus of any one of clauses 27-29, wherein the one or more processors are further configured to: generate the at least two key sections associated with the second key of the key pair using multiparty computation (MPC); and send the at least two key sections to the at least two entities.
Clause 31. The apparatus of clause 30, wherein, to generate the at least two key sections, the one or more processors are configured to generate at least three key sections, and wherein only a subset of the at least three key sections is required to decrypt the encrypted NFT information.
Clause 32. The apparatus of any one of clauses 27-31, wherein the one or more processors are configured to decrypt the encrypted NFT information in response to a request for distribution of the NFT.
Clause 33. The apparatus of any one of clauses 27-32, wherein the at least two key sections include a first key section retrieved from a creator of the NFT.
Clause 34. The apparatus of clause 33, wherein the at least two key sections further include: a second key section retrieved from an owner of the NFT; and a third key section retrieved from an arbiter.
Clause 35. The apparatus of any one of clauses 27-34, wherein the encrypted NFT information includes encrypted metadata associated with the NFT.
Clause 36. The apparatus of clause 35, wherein the one or more processors are configured to: receive, in response to a request to view an object associated with the NFT, identifying information associated with the encrypted NFT information; and retrieve the encrypted NFT information from a database based on the identifying information.
Clause 37. The apparatus of clause 36, wherein the identifying information includes a hash function or a checksum associated with the encrypted NFT information.
Clause 38. The apparatus of any one of clauses 35-37, wherein the one or more processors are configured to: encrypt an object associated with the NFT, wherein the encrypted metadata includes a hash function or checksum corresponding to the encrypted object.
Clause 39. The apparatus of any one of clauses 27-38, wherein the at least two key sections include: a first key section retrieved from a platform database; and a second key section retrieved from an owner of the NFT.
Clause 40. The apparatus of any one of clauses 27-39, wherein the first key comprises a public key, and wherein the second key comprises a private key.
Clause 41. An apparatus for non-fungible token (NFT) generation, comprising: a memory; and one or more processors coupled to the memory, the one or more processors being configured to: receive an object for generation of an NFT; process the object to identify a characteristic of the object; identify one or more geographical regions where the NFT associated with the object can be sold based on the characteristic of the object; receive a selection of at least one of the one or more geographical regions; and list the NFT in the at least one of the one or more geographical regions in accordance with the selection.
Clause 42. The apparatus of clause 41, wherein the one or more geographical regions include one or more countries or counties.
Clause 43. The apparatus of any one of clauses 41-42, wherein, to process the object to identify the characteristic of the object, the one or more processors are configured to identify a type of content associated with the object.
Clause 44. The apparatus of clause 43, wherein the object includes an image, and wherein the type of content associated with the image is identified using image recognition.
Clause 45. The apparatus of any one of clauses 43-44, wherein, to identify the one or more geographical regions, the one or more processors are configured to identify whether one or more regulations associated with the one or more geographical regions allows sale or display of the type of content.
Clause 46. The apparatus of any one of clauses 43-45, wherein the one or more geographical regions are identified based on one or more rules from a rules engine.
Clause 47. An apparatus for non-fungible token (NFT) processing, comprising: a memory; and one or more processors coupled to the memory, the one or more processors being configured to: extract information associated with an NFT in response to a request for an object corresponding to the NFT; retrieve the object corresponding to the NFT; encode the information into the object to yield an encoded NFT object; and output the encoded NFT object.
Clause 48. The apparatus of clause 47, wherein the information associated with the NFT includes information associated with a creator of the object.
Clause 49. The apparatus of any one of clauses 47-48, wherein the information associated with the NFT includes metadata of the object.
Clause 50. The apparatus of any one of clauses 47-49, wherein the object comprises an image.
Clause 51. The apparatus of clause 50, wherein the information is encoded based on a dominant color associated with the image.
Clause 52. The apparatus of any one of clauses 47-51, wherein the encoded NFT object is visually the same as the object prior to encoding the information into the object.
Clause 53. A non-transitory computer-readable medium having instructions, that when executed by one or more processors, cause the one or more processors to: encrypt information associated with a non-fungible token (NFT) using a first key of a key pair to yield encrypted NFT information; retrieve, from at least two entities, at least two key sections associated with a second key of the key pair; decrypt the encrypted NFT information associated with the NFT via the at least two key sections to yield decrypted NFT information; and output the decrypted NFT information.
Clause 54. The non-transitory computer-readable medium of Clause 53, wherein the instructions, when executed by the one or more processors, cause the one or more processors to perform operations according to any of Clauses 2 to 14.
Clause 55. A non-transitory computer-readable medium having instructions, that when executed by one or more processors, cause the one or more processors to: receive an object for generation of a non-fungible token (NFT); process the object to identify a characteristic of the object; identify one or more geographical regions where the NFT associated with the object can be sold based on the characteristic of the object; receive a selection of at least one of the one or more geographical regions; and list the NFT in the at least one of the one or more geographical regions in accordance with the selection.
Clause 56. The non-transitory computer-readable medium of Clause 55, wherein the instructions, when executed by the one or more processors, cause the one or more processors to perform operations according to any of Clauses 16 to 20.
Clause 57. A non-transitory computer-readable medium having instructions, that when executed by one or more processors, cause the one or more processors to: extract information associated with a non-fungible token (NFT) in response to a request for an object corresponding to the NFT; retrieve the object corresponding to the NFT; encode the information into the object to yield an encoded NFT object; and output the encoded NFT object.
Clause 58. The non-transitory computer-readable medium of Clause 57, wherein the instructions, when executed by the one or more processors, cause the one or more processors to perform operations according to any of Clauses 22 to 26.

1. A method for non-fungible token (NFT) processing, comprising:
encrypting information associated with an NFT using a first key of a key pair to yield encrypted NFT information;
retrieving, from at least two entities, at least two key sections associated with a second key of the key pair;
decrypting the encrypted NFT information associated with the NFT via the at least two key sections to yield decrypted NFT information; and
outputting the decrypted NFT information.

2. The method of claim 1, wherein:
encrypting the information associated with the NFT comprises encrypting an object associated with the NFT;
encrypting the object associated with the NFT comprises watermarking an NFT object using the first key of the key pair; and
decrypting the encrypted NFT information comprises unwatermarking the watermarked NFT object via the at least two key sections.

3. (canceled)

4. The method of claim 1, further comprising:
generating the at least two key sections associated with the second key of the key pair using multiparty computation (MPC); and
sending the at least two key sections to the at least two entities;
wherein generating the at least two key sections comprises generating at least three key sections; and
wherein only a subset of the at least three key sections is required to decrypt the encrypted NFT information.

5. (canceled)

6. The method of claim 1, wherein decrypting the encrypted NFT information is in response to a request for distribution of the NFT.

7. The method of claim 1, wherein the at least two key sections comprise:
a first key section retrieved from a creator of the NFT;
a second key section retrieved from an owner of the NFT; and
a third key section retrieved from an arbiter.

8. (canceled)

9. The method of claim 1, wherein the encrypted NFT information comprises encrypted metadata associated with the NFT.

10. The method of claim 9, further comprising:
receiving, in response to a request to view an object associated with the NFT, identifying information associated with the encrypted NFT information; and
retrieving the encrypted NFT information from a database based on the identifying information.

11. The method of claim 10, wherein the identifying information comprises a hash function or a checksum associated with the encrypted NFT information.

12. The method of claim 9, further comprising:
encrypting an object associated with the NFT, wherein the encrypted metadata comprises a hash function or checksum corresponding to the encrypted object.

13. The method of claim 1, wherein the at least two key sections comprise:
a first key section retrieved from a platform database; and
a second key section retrieved from an owner of the NFT.

14. (canceled)

15. A method for non-fungible token (NFT) generation, comprising:
receiving an object for generation of an NFT;
processing the object to identify a characteristic of the object;
identifying one or more geographical regions where the NFT associated with the object can be sold based on the characteristic of the object;
receiving a selection of at least one of the one or more geographical regions; and
listing the NFT in the at least one of the one or more geographical regions in accordance with the selection.

16. The method of claim 15, wherein the one or more geographical regions comprises one or more countries or counties.

17. The method of claim 15, wherein the processing the object to identify the characteristic of the object comprises identifying a type of content associated with the object.

18. The method of claim 17, wherein the object comprises an image, and wherein the type of content associated with the image is identified using image recognition.

19. The method of claim 17, wherein identifying the one or more geographical regions comprises identifying whether one or more regulations associated with the one or more geographical regions allows sale or display of the type of content.

20. The method of claim 17, wherein the one or more geographical regions are identified based on one or more rules from a rules engine.

21. A method for non-fungible token (NFT) processing, comprising:
extracting information associated with an NFT in response to a request for an object corresponding to the NFT;
retrieving the object corresponding to the NFT;
encoding the information into the object to yield an encoded NFT object; and
outputting the encoded NFT object.

22. The method of claim 21, wherein the information associated with the NFT comprises information associated with a creator of the object.

23. (canceled)

24. The method of claim 21, wherein the object comprises an image; and
wherein the information is encoded based on a dominant color associated with the image.

25. (canceled)

26. The method of claim 21, wherein the encoded NFT object is visually the same as the object prior to encoding the information into the object.

27.-55. (canceled)
